(19) United States
(12) Patent Application Publication
(10) Pub. No.: US 2025/0272897 A1
(43) Pub. Date: Aug. 28, 2025

(54) DATA AUGMENTATION METHOD AND APPARATUS FOR MACHINE LEARNING AND APPLICATIONS THEREOF

(71) Applicants: SK hynix Inc., Icheon-si (KR); KOREA UNIVERSITY RESEARCH AND BUSINESS FOUNDATION, Seoul (KR)

(72) Inventors: Kyung Hye Kim, Icheon-si (KR); Heejoong Roh, Icheon-si (KR); Munki Jo, Icheon-si (KR); Seoung Bum Kim, Seoul (KR); Hansam Cho, Seoul (KR); Insung Baek, Seoul (KR); Yongwon Jo, Seoul (KR); Jinsoo Bae, Seoul (KR); Sungsu Kim, Seoul (KR)

(21) Appl. No.: 19/064,582

(22) Filed: Feb. 26, 2025

(30) Foreign Application Priority Data
Feb. 28, 2024 (KR) 10-2024-0028621

(51) Int. Cl. G06T 11/60; G06T 7/70; G06V 10/25; H04N 1/40

(52) U.S. Cl. CPC G06T 11/60; G06T 7/70; G06V 10/25; H04N 1/40012; G06T 2207/10061

(57) ABSTRACT

Data augmentation methods and apparatus for machine learning, and utilization thereof, are disclosed. A computer-implemented method for data augmentation in electron microscope imaging, the method comprising: receiving, using a processor, an input image captured by an electron microscope; processing, using a processor, the input image to generate an augmented image dataset, the processing comprising: generating a first transformed image by converting an interior region of an object region of interest in the input image to a single color; generating a second transformed image by converting a region other than the object region of interest in the input image to a single color; and generating a third transformed image by modifying pixel positions exclusively within the interior region of the object region of interest in the input image; and outputting the augmented image dataset to train a machine learning model.

### CROSS-REFERENCES TO RELATED APPLICATION

The present application claims, under 35 U.S.C. § 119(a), the benefit of Korean Patent Application No. 10-2024-0028621, filed on Feb. 28, 2024 which is hereby incorporated by reference in its entirety.

### BACKGROUND

### 1. Field

Embodiments of the present disclosure relate to data-related processing methods and devices, and more particularly, to data augmentation methods and devices and their utilization for machine learning.

### 2. Description of the Related Art

Consistent and accurate measurement of scanning electron microscope (SEM) and transmission electron microscope (TEM) images is critical for quality control of semiconductor devices. One approach to ensuring image consistency is the use of automated metrology algorithms, where artificial intelligence models, such as machine learning models, can enhance metrology accuracy. However, acquiring TEM images requires destructive wafer processing, resulting in a labor-intensive and costly image collection process. Training a sophisticated AI model necessitates large amounts of data, but the difficulty in obtaining TEM images poses a significant limitation. To address this data scarcity, data augmentation techniques can be utilized to generate additional training data through various transformations.

Conventional data augmentation techniques enhance datasets by modifying image's shape, color, or size. Shape transformation techniques generate variations through rotation and symmetry operations; color transformation techniques introduce diversity by adjusting focus, brightness, and contrast; and size transformation techniques produce new images by cropping portions of the image and resizing the cropped image to match the original image.

However, applying traditional data augmentation techniques to electron microscope images, particularly TEM images, may be ineffective. This is because TEM images exhibit minimal variations in the shape and size of objects within the TEM images due to standardized imaging guidelines, and patterns within the same object can vary depending on imaging angles and interactions with the environment and specimen. In addition, TEM images often suffer from boundary information loss, making automated metrology algorithm development more challenging. Furthermore, the texture within the object region of interest in a TEM image can appear randomized due to acquisition conditions and specimen properties. In TEM-based metrology, object boundary information is crucial, and if standard augmentation techniques distort the texture of the TEM image in a predefined manner, they may also alter the metrology region's boundaries, thereby degrading metrology accuracy. For the above reasons, conventional data augmentation techniques may not be directly applicable to TEM images.

### SUMMARY

The present disclosure provides a data augmentation method and device specifically designed for images taken by an electron microscope in order to enhance the performance of automatic measurements based on machine learning in the manufacturing and development of semiconductor devices and the like.

In addition, a technical objective of the present disclosure is to provide a data augmentation method and apparatus that enhance the object recognition performance of a machine learning model by accurately recognizing the boundaries of an object region of interest (or metrological region of interest) in an electron microscope image.

In addition, the present disclose provides a method for deriving object regions of interest from electron microscope images, wherein the aforementioned data augmentation method is applied.

Another objective of the present disclosure is to provide an apparatus for deriving an object region of interest from an electron microscope image using the aforementioned data augmentation device.

The present disclosure is not limited to the objectives mentioned above. Additional objectives will be apparent to those skilled in the art from the following description.

According to one embodiment of the present invention, a computer-implemented method for data augmentation in electron microscope imaging, the method comprising: receiving, using a processor, an input image captured by an electron microscope; and processing, using a processor, the input image to generate an augmented image dataset, the processing comprising: generating a first transformed image by converting an interior region of an object region of interest in the input image to a single color; generating a second transformed image by converting a region other than the object region of interest in the input image to a single color; and generating a third transformed image by modifying pixel positions exclusively within the interior region of the object region of interest in the input image; and outputting the augmented image dataset to train a machine learning model.

In at least one of generating the first transformed image or generating the second transformed image, wherein the single color is selected from black, white, or gray.

The single color may be black.

The step of generating the third transformed image is performed not to change a contour shape of the object region of interest.

The step of generating the third transformed image is performed not to change a size of the object region of interest.

In at least one of generating the first transformed image, generating the second transformed image, or generating the third transformed image includes utilizing positional information of the object region of interest obtained from a correct image or reference image.

The input image may be a transmission electron microscope (TEM) image or a scanning electron microscope (SEM) image.

According to another embodiment of the present invention, there is provided to a computer-implemented method of deriving object regions of interest from images captured by an electron microscope, the method comprising: receiving an augmented image dataset generated using the data augmentation method of claim 1; training a machine learning model using the augmented image dataset; and deriving an object region of interest using the trained machine learning model.

According to another embodiment of the present invention, an electronic device for augmenting image data for machine learning on images captured by an electron microscope, the device comprising: a processor; and a memory storing one or more instructions that, when executed by the processor, cause the processor to: receiving an input image captured by the electron microscope; and generating an augmented image dataset by applying data augmentation techniques to the input images, wherein generating the augmented image dataset includes performing at least one of: generating a first transformed image by converting an interior region of an object region of interest in the input image to a single color; generating a second transformed image by converting a region other than the object region of interest in the input image to a single color; and generating a third transformed image by modifying pixel positions exclusively within the interior region of the object region of interest in the input image.

In at least one of generating the first transformed image or generating the second transformed image, the single color is selected from black, white, or gray.

The single color is black.

The step of generating the third transformed image is performed not to change a contour shape of the object region of interest.

The step of generating the third transformed image is performed not to change a size of the object region of interest.

In at least one of generating the first transformed image, generating the second transformed image, and generating the third transformed image includes utilizing positional information of the object region of interest obtained from a correct image or reference image.

The input image may be a transmission electron microscope (TEM) image or a scanning electron microscope (SEM) image.

According to another embodiment of the present invention, there is provided an electronic device for deriving object regions of interest from images captured by an electron microscope using machine learning, the device comprising: the electronic device of claim 9.

According to embodiments of the present disclosure, a data augmentation method and apparatus suitable for electron microscope images may be implemented to enhance the performance of automatic measurements based on machine learning in the manufacturing and development of semiconductor devices and the like. In addition, according to embodiments of the present disclosure, a data augmentation method and apparatus may be implemented to improve a machine learning model's ability to accurately recognize the boundary of an object region of interest (or measurement region of interest) within electron microscope images, thereby enhancing the object recognition performance.

According to embodiments of the present disclosure, it is possible to implement a method for deriving an object region of interest from an electron microscope image, wherein the aforementioned data augmentation method is applied. Likewise, according to embodiments of the present disclosure, an apparatus for deriving an object region of interest from an electron microscope image may be implemented by applying the aforementioned data augmentation apparatus.

According to embodiments, methods and devices may be implemented to enhance image metrology performance based on artificial intelligence models by augmenting limited image data and improving object recognition accuracy while preserving boundary information in electron microscope images, such as TEM images and SEM images.

The effects of the present invention are not limited to the aforementioned effects, and may be extended in various ways without departing from the underlying technical concepts and scope of the present invention.

### BRIEF DESCRIPTION OF THE DRAWINGS

FIG. 1 illustrates a data augmentation method for electron microscope images, in accordance with one embodiment of the present disclosure.

FIG. 2 illustrates an exemplary data augmentation method for electron microscope images, in accordance with one embodiment of the present disclosure.

FIG. 3 illustrates an example of how a machine learning model can be used to derive an object region of interest from an electron microscope image, in accordance with one embodiment of the present disclosure.

FIG. 4 illustrates a data augmentation method using shape deformation techniques, which may be compared to embodiments of the present disclosure.

FIG. 5 illustrates a data augmentation method using a color transformation technique, which may be compared to embodiments of the present disclosure.

FIG. 6 illustrates a data augmentation method using a size deformation technique, which may be compared to embodiments of the present disclosure.

FIG. 7 illustrates an exemplary data augmentation method for electron microscope images, in accordance with another embodiment of the present disclosure.

FIG. 8 illustrates an example of how a machine learning model can be used to derive an object region of interest from an electron microscope image, in accordance with another embodiment of the present disclosure.

FIG. 9 illustrates a data augmentation method using texture deformation techniques, which may be compared to embodiments of the present disclosure.

FIG. 10 illustrates an example of how a machine learning model can be used to derive an object region of interest from an electron microscope image, in accordance with another embodiment of the present disclosure.

FIG. 11 illustrates an electronic device for augmenting image data for machine learning on electron microscope images, in accordance with one embodiment of the present disclosure.

FIGS. 12 through 16 illustrate input images, correct images, and results of a method according to an embodiment, for samples obtained from five manufacturing processes listed in Table 1.

### DETAILED DESCRIPTION

Hereinafter, the embodiments of the present disclosure will be described in detail with reference to the accompanying drawings.

The embodiments of the present disclosure to be described below are provided to explain the invention more clearly to those having common knowledge in the related art, and the scope of the invention is not limited by the following embodiments. The following embodiments may be modified in many different forms.

The terms used in this specification are intended to describe specific embodiments and are not intended to limit the invention. Terms used herein in the singular form may include the plural form, unless the context clearly indicates otherwise. Furthermore, the terms “comprise” and/or “comprising” as used herein are intended to specify the presence of the mentioned shapes, steps, numbers, motions, absences, elements, and/or groups thereof, and are not intended to exclude the presence or addition of one or more other shapes, steps, numbers, motions, absences, elements, and/or groups thereof. Furthermore, as used herein, the term “connected” is intended to mean not only that certain elements are directly connected, but also that they are indirectly connected by the interposition of other elements between them.

In addition, designations such as “first” and “second,” “upper or top,” and “lower or bottom” in the description herein are intended to distinguish members and are not intended to limit the members themselves or to imply a particular order, but rather to indicate a relative positional relationship and not to limit the specific instances in which other members may be introduced into direct contact with or at the interface between the members. The same interpretation may be applied to other expressions describing relationships between components.

Further, when the present disclosure refers to a member being located “on” another member, this includes not only when a member is abutting another member, but also when there is another member between the two members. As used herein, the term “and/or” includes any one of the enumerated items and any combination of one or more of them. In addition, the terms “about,” “substantially,” and the like as used in the disclosure are intended to mean at or near the range of numbers or degrees, taking into account inherent manufacturing and material tolerances, and to prevent infringers from taking unfair advantage of the disclosure where precise or absolute numbers are stated, which are provided for the purpose of illustration.

Embodiments of the present invention will now be described in detail with reference to the accompanying drawings. The sizes or thicknesses of the areas or parts shown in the accompanying drawings may be somewhat exaggerated for clarity and ease of description. Throughout the detailed description, like reference numerals designate like components.

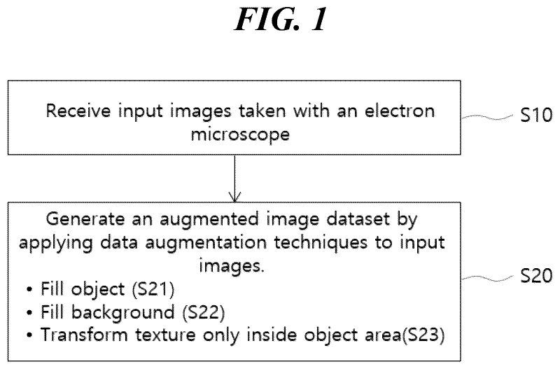

FIG. 1 illustrates a data augmentation method for electron microscope images, in accordance with one embodiment of the present disclosure.

Referring to FIG. 1, the data augmentation method may include generating an augmented image dataset for machine learning, using an electronic device that includes a processor, for an image captured by an electron microscope, i.e., an electron microscope image. In particular, the data augmentation method may include step S10, in which the processor of the electronic device receives an input image captured by the electron microscope, and step S20, in which the processor applies a data augmentation technique to the input image to generate the augmented image dataset.

Step S20 may include one or more of the following: generating a first transformed image (S21), in which an interior region of an object region of interest in the input image is transformed to a single color, generating a second transformed image (S22), in which a region outside the object region of interest in the input image is transformed to a single color, and generating a third transformed image (S23), in which pixel positions are modified only in the interior of the object region of interest in the input image. The object region of interest may be referred to as a ‘metrology region of interest’ or a ‘metrology target region of interest’. The object region of interest may represent a target area (or target object region) in an electron microscope image of a device or substrate that has undergone a semiconductor manufacturing process, where measurement (including automated measurement) is to be performed. In a given input image, an object region of interest may be singular or plural.

Step S21 may include generating the first transformed image in which the entire interior region of the object region of interest in the input image is converted to a single color. Step S21 may be referred to as a ‘Fill object’ step. In step S21, the entire region inside a boundary line of the object region of interest may be converted to a single color. In step S21, the entire region inside the boundary line of the object region of interest, including the boundary line of the object region of interest, may be converted to a single color. At this time, the region outside the object region of interest may not be transformed, that is, the image may not be transformed in the remaining region except for the object region of interest.

Step S22 may include generating the second transformed image in which all regions of the input image, except for the object region of interest, are converted to a single color. The regions except for the object of interest region may be referred to as the background region. Step S22 may be referred to as a ‘Fill background’ step. In step S22, the entire region outside the boundary line of the object region of interest may be converted to a single color. During this process, the interior region of the object region of interest remains unchanged.

According to one embodiment, the single color used in step S21 and/or step S22 may be any one of black, white, and gray. In a gray-scale image, each pixel may have a pixel value ranging from 0 to 255, referred to as a pixel intensity. In this context, a pixel value of 0 corresponds to black, a pixel value of 255 corresponds to while, and a pixel value between 0 and 255 corresponds to gray. Thus, in this embodiment, black is represented by a pixel value of 0,white by a pixel value of 255, and gray by any pixel value greater than 0 and less than 255.

According to one embodiment, the preferred single color may be black. In step S21, the first transformed image may be generated in which the interior region of the object region of interest in the input image is converted to black. Similarly, in step S22, the second transformed image may be generated in which the background region, i.e., the region other than the object region of interest, is converted to black. This enhances the distinction between the object region of interest and the background region in the transformed images, thereby improving the effectiveness of data augmentation. However, a similar effect may be obtained even if the single color is white or gray instead of black.

Step S23 may include generating the third transformed image in which pixel positions are changed only within the object region of interest in the input image. By changing pixel positions while restricting the changes to the interior of the object region of interest, the third transformed image with changed pixel positions exclusively inside the object region of interest may be generated. This change affects the texture (i.e., the image texture) within the object region of interest, effectively transforming it. Thus, step S23 may be considered a step of generating a deformed image with a texture deformed by changing the pixel positions only within the object region of interest. Texture transformation, in this context, may refer to image distortion within that region. The pixel positions in the image may be represented by a grid or lattice of points, and changing the positions of these points results in the transformation or distortion of the image inside the object region of interest. In step S23, the image outside the object region of interest remains unchanged, meaning no transformations are applied to areas outside the object region of interest.

According to one embodiment, step S23 may be performed in a manner that preserves the shape of the outline of the object region of interest, meaning the boundary of the object region of interest remains unchanged. In addition, step S23 may be performed such that the size of the object region of interest does not change, ensuring that its horizontal and vertical dimensions do not change. The object region of interest may correspond to a measurement region of interest, which is the subject of the measurement. By preserving both the contour shape and size of the object region of interest in step S23, the integrity of its boundary surface (or boundary line) information is maintained. This preservation may enhance the boundary surface (boundary line) recognition performance of the machine learning model (i.e., the artificial intelligence model).

According to an embodiment, in one or more of steps S21, S22, and S23, the processor may be configured to utilize position information of the object region of interest obtained from a correct image or reference image when generating the transformed image. Based on the input image, the correct image or reference image may be generated in which the object region of interest is clearly represented. The processor may then extract the position information of the object region of interest from the correct image or reference image and use it to perform one or more of steps S21, S22, and S23. In some embodiments, the processor may utilize the position information in all of steps S21, S22, and S23. The correct or reference image may be generated either manually or automatically.

According to one embodiment, the input image may be a transmission electron microscope (TEM) image or a scanning electron microscope (SEM) image. Consistent and accurate measurement of SEM images and TEM images may be important for manufacturing, development, quality control, and the like of semiconductor devices. However, acquiring TEM images is labor-intensive and costly since it requires destructive wafer analysis. As a result, data augmentation-transforming existing data to generate larger datasets-plays a crucial role in addressing the shortage of training data.

TEM images exhibit small variations in the shape and size of objects due to standardized imaging guidelines, but patterns within the same object may vary depending on the acquisition angle and interactions with the environment and specimen. In addition, TEM images often suffer from information loss at object boundaries, which can make it difficult to develop automated metrology algorithms. Furthermore, the texture inside the object region of interest may appear randomized due to the acquisition environment and specimen properties. Given these characteristics, conventional data enhancement techniques may not be directly applicable to electron microscope images such as TEM images.

The data augmentation methods according to embodiments of the present disclosure may be suitable for electron microscope images, such as TEM images or SEM images, and may be effectively applied to improve the performance of automated measurements based on machine learning.

According to one embodiment of the present disclosure, a method for data augmentation is provided for generating an augmented image dataset for machine learning using an electronic device that includes a processor. This method applies to an image captured by an electron microscope and aims to enhance training data for machine learning applications. The method may include: receiving, using the processor of the electronic device, an input image captured by the electron microscope; and generating the augmented image dataset by applying a data augmentation technique to the input image using the processor, wherein one or more of the following transformations are performed: generating a first transformed image by converting the interior region of the object region of interest in the input image to a single color; generating a second transformed image by converting a region other than the object region of interest in the input image to a single color; and generating a third transformed image by modifying pixel positions only in the interior region of the object region of interest in the input image.

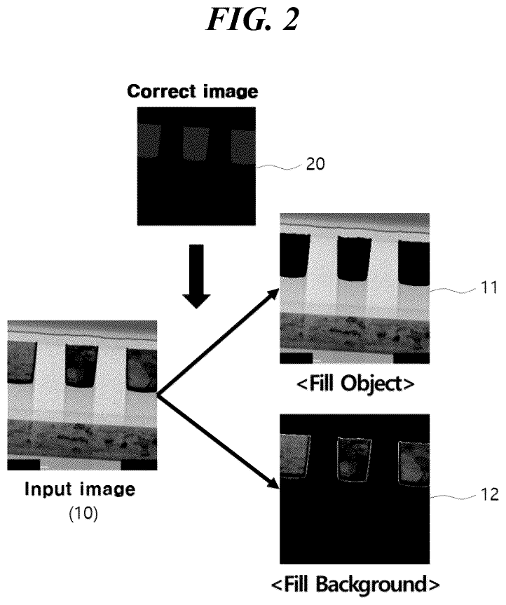

FIG. 2 illustrates an exemplary data augmentation method for electron microscope images, in accordance with one embodiment of the present disclosure.

Referring to FIG. 2, a first transformed image 11 may be generated from an input image 10 captured by an electron microscope, wherein an interior region of an object region of interest is converted to a single color. In addition, a second transformed image 12 may be generated from the input image 10, wherein regions other than the object region of interest are transformed to a single color. The step of generating the first transformed image 11 may correspond to the step S21 described in FIG. 1. Accordingly, the step of generating the first transformed image 11 may be referred to as the ‘Fill object’ step. The step of generating the second transformed image 12 may correspond to the step S22 described in FIG. 1. Accordingly, the step of generating the second transformed image 12 may be referred to as the ‘Fill background’ step. In the Fill object and Fill background steps, the single color may be, for example, black. The input image 10 may be a TEM image. According to one embodiment, when generating the first transformed image 11 and the second transformed image 12, the processor may utilize position information of the object region of interest obtained from the input image 10 and a correct image 20.

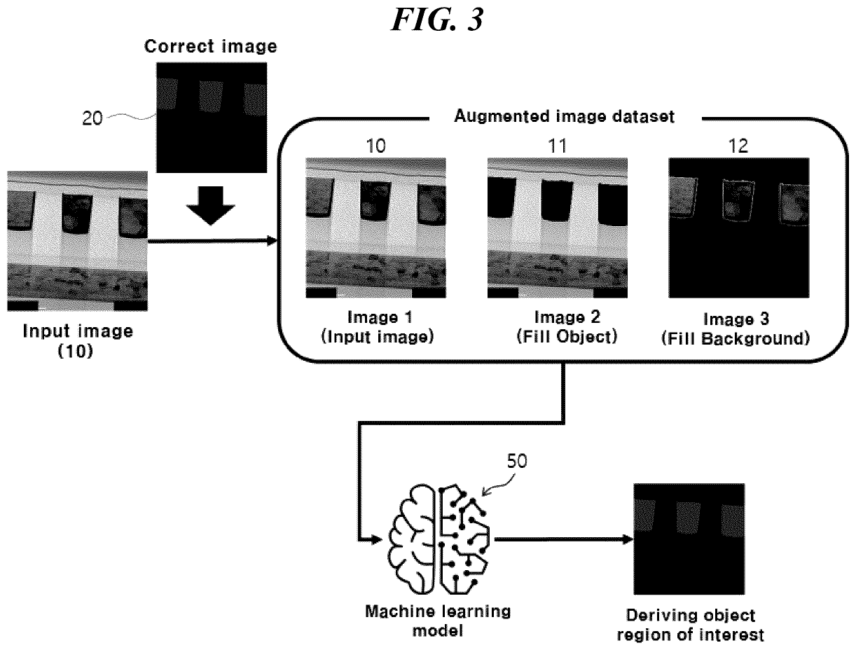

FIG. 3 illustrates an example of how a machine learning model can be used to derive an object region of interest from an electron microscope image, in accordance with one embodiment of the present disclosure.

Referring to FIG. 3, a method for deriving an object region of interest from an electron microscope image according to an embodiment of the present disclosure may include generating an augmented image dataset using the data augmentation method described with reference to FIG. 2, outputting the augmented image dataset for training a machine learning model 50, training the machine learning model 50 with the augmented image dataset, and using the trained machine learning model 50 to derive an object region of interest (metrology region of interest) from the electron microscope image. The augmented image dataset may include an input image 10, a first transformed image 11, and a second transformed image 12. Using the learned machine learning model 50, predetermined measurements may be performed on the object region of interest derived from the electron microscopic image. The measurements may include, for example, dimensional measurements.

According to embodiments of the present disclosure, data augmentation may be performed by applying the Fill object and Fill background techniques to the input image 10, allowing for the generation of a large amount of augmented data. The augmented image dataset may then be used to train the machine learning model 50, which is designed to estimate the location of an object of interest in the electron microscope image. By utilizing the augmented image dataset for training the machine learning model 50, the machine learning model 50 may be encouraged to focus on boundaries of objects within the image. Converting the interior or exterior of the object region of interest to a single color enhances the contrast between the object and the background, making the boundary more distinguishable for the machine learning model 50. As a result, the ability of the machine learning model 50 to recognize the boundary of the object in the electron microscope image may be significantly improved, leading to enhanced object recognition performance. Additionally, according to one embodiment, the machine learning model 50 may be further trained to accurately estimate the location of the object by utilizing a correct image 20, which provides precise position information for improved learning.

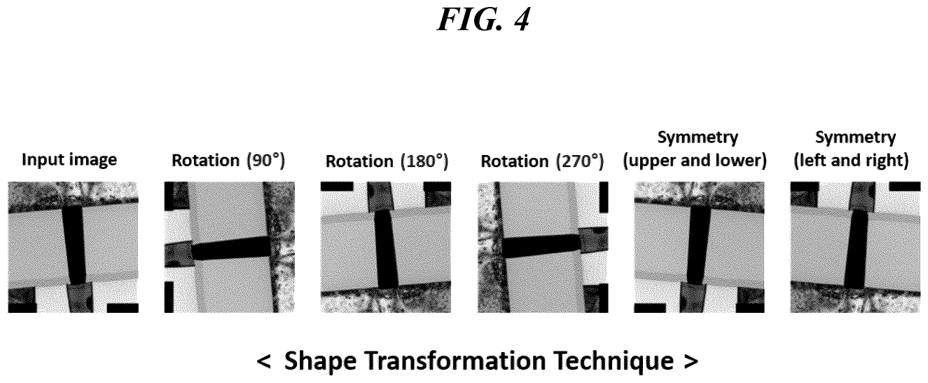

FIG. 4 illustrates a data augmentation method using shape deformation techniques, which may be compared to embodiments of the present disclosure.

Referring to FIG. 4, the shape deformation technique is a method for generating various transformed images by applying rotation and symmetry to an input image.

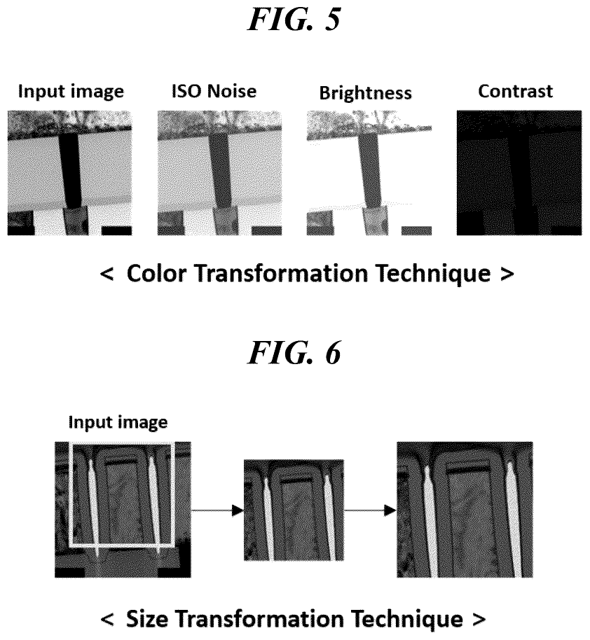

FIG. 5 illustrates a data augmentation method using a color transformation technique, which may be compared to embodiments of the present disclosure.

Referring to FIG. 5, the color transformation technique is a method for generating various transformed images by changing the focus, brightness, and contrast of an image. In this process, the brightness or color contrast is varied across the image.

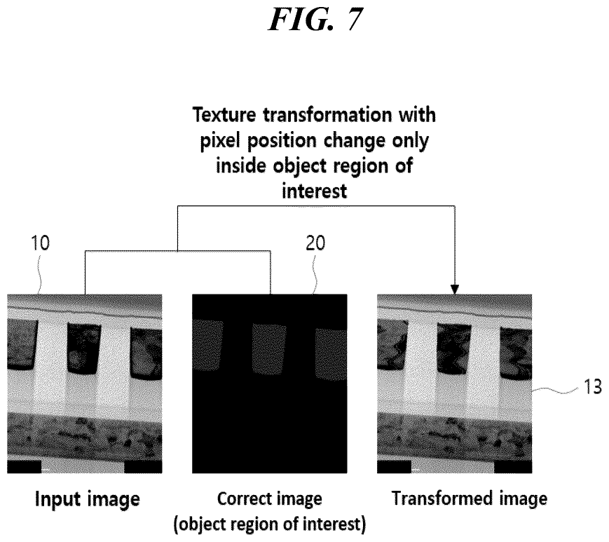

FIG. 6 illustrates a data augmentation method using a size transformation technique, which may be compared to embodiments of the present disclosure.

Referring to FIG. 6, the size transformation technique involves cropping a portion of an image and then resizing the cropped image to match the size of the original image. This technique effectively alters a size of an object within the image.

The methods described with reference to FIGS. 4 through 6 may not be directly suitable or effective for verbatim application to images captured by an electron microscope. Due to the unique characteristics of electron microscope images-such as low contrast, noise, and structural distortions-traditional transformation techniques like shape deformation, color transformation, and size transformation may not preserve critical features necessary for accurate analysis. Therefore, specialized adaptations of these techniques may be required to enhance their applicability to electron microscope images

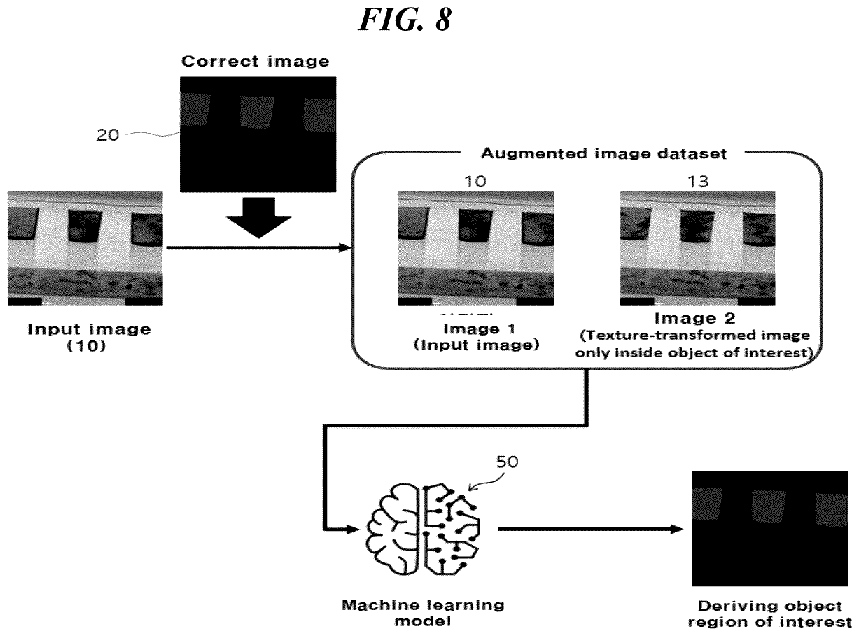

FIG. 7 illustrates an exemplary data augmentation method for electron microscope images, in accordance with another embodiment of the present disclosure.

Referring to FIG. 7, a third transformed image 13 may be generated from an input image 10 captured by an electron microscope, where pixel positions have been changed only in the interior of an object region of interest. The step of generating the third transformed image 13 may correspond to the step S23 described in FIG. 1. By changing the pixel positions in the input image 10 while restricting the changes to the interior of the object region of interest, the third transformed image 13 may be generated having changed pixel positions exclusively within the object region of interest. This transformation modifies the texture inside the object region of interest, while ensuring that the outline shape and size of the object region of interest remain unchanged. Additionally, areas outside the object region of interest remain unchanged. According to one embodiment, in generating the third transformed image 13, the processor may utilize position information of the object region of interest obtained from the input image 10 and a correct image 20.

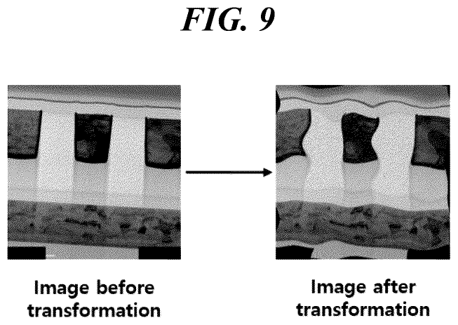

FIG. 8 illustrates an example of how a machine learning model can be used to derive an object region of interest from an electron microscope image, in accordance with another embodiment of the present disclosure.

Referring to FIG. 8, a method for deriving an object region of interest from an electron microscope image according to one embodiment of the present disclosure may include generating an augmented image dataset using the data augmentation method described with reference to FIG. 7, training a machine learning model 50 with the augmented image dataset, and using the trained machine learning model 50 to derive the object region of interest (metrology region of interest) from the electron microscope image. The augmented image dataset may include an input image 10 and a third transformed image 13. There may be a singular or plurality of third transformed images 13. Using the trained machine learning model 50, predetermined measurements may be performed on the object region of interest derived from the electron microscope image.

In embodiments of the present disclosure, data augmentation may be performed utilizing texture deformation techniques within the object region of interest (metrology region of interest), and the augmented data may be leveraged to generate a larger dataset. The augmented image dataset may then be used to train the machine learning model 50, which can estimate the location of the object of interest within the electron microscope image. In addition, the machine learning model 50 may be further trained to enhance its accuracy in estimating the location of the object of interest by utilizing a correct image 20.

Embodiments of the present disclosure may provide a texture transformation-based data augmentation technique that enhances scarce image data while preserving critical information within the image. Specifically, this technique may augment limited image data while maintaining the integrity of object boundary information. Even when the available training data is insufficient, the learning performance of the machine learning model 50 may be improved through data augmentation that selectively varies the texture within the object region of interest (measurement region of interest). By ensuring that texture transformations do not compromise object boundaries, this data augmentation technique enables the machine learning model 50 to more effectively recognize the boundaries of the object region of interest, ultimately enhancing the object recognition performance of the machine learning model 50.

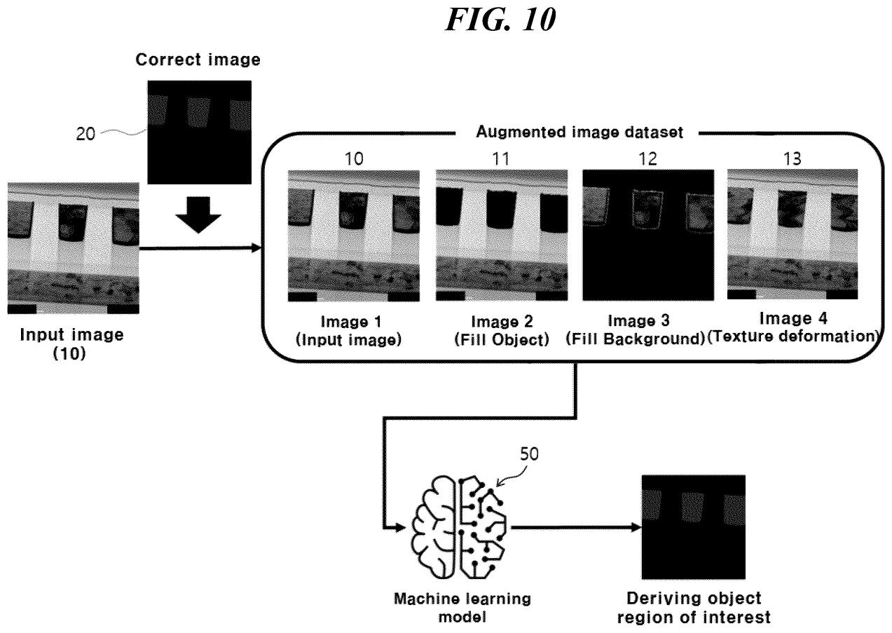

FIG. 9 illustrates a data augmentation method using texture transformation techniques, which may be compared to embodiments of the present disclosure.

Referring to FIG. 9, pixel positions within an image may be changed based on the original image information (i.e., image data prior to deformation). This transformation modifies the texture by changing pixel positions across all regions of the image. As a result, the outline shape of an object region of interest may be deformed, leading to changes in its boundary information. In addition, the horizontal and vertical dimensions of the object region of interest may change. Such modifications can negatively impact measurement accuracy and therefore may not be suitable for direct application to images acquired by an electron microscope.

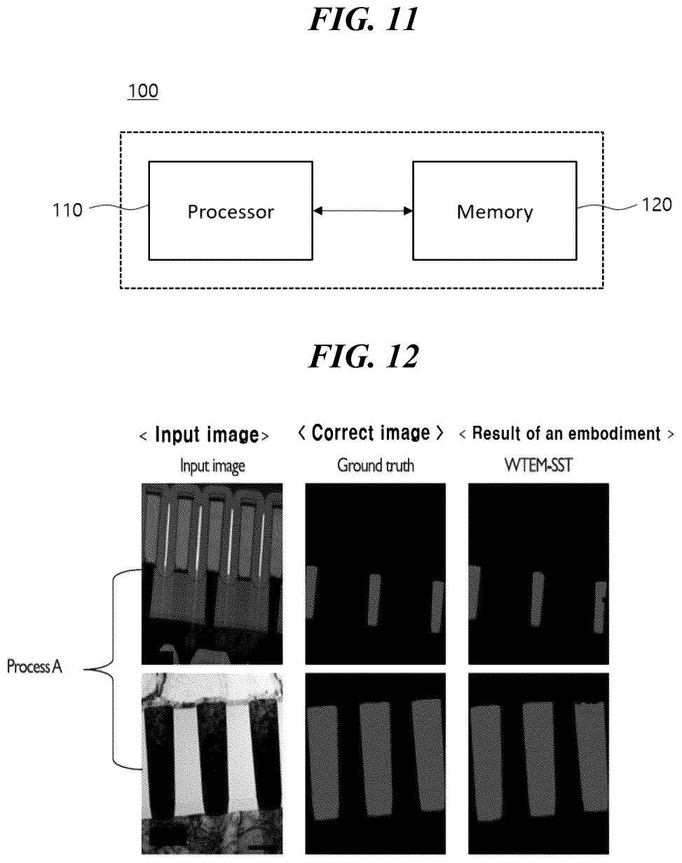

FIG. 10 illustrates an example of how a machine learning model can be used to derive an object region of interest from an electron microscope image, in accordance with another embodiment of the present disclosure.

Referring to FIG. 10, a method for deriving an object region of interest from an electron microscope image according to an embodiment may include generating an augmented image dataset using the data augmentation method described with reference to FIGS. 2 and 7, training a machine learning model 50 with the augmented image dataset, and utilizing the trained machine learning model 50 to derive the object region of interest (metrology region of interest) from the electron microscope image. The augmented image dataset may include an input image 10, a first transformed image 11, a second transformed image 12, and a third transformed image 13. There may be a singular or plurality of third transformed images 13. In some embodiments, there may be a plurality of first transformed images 11 and a plurality of second transformed images 12.

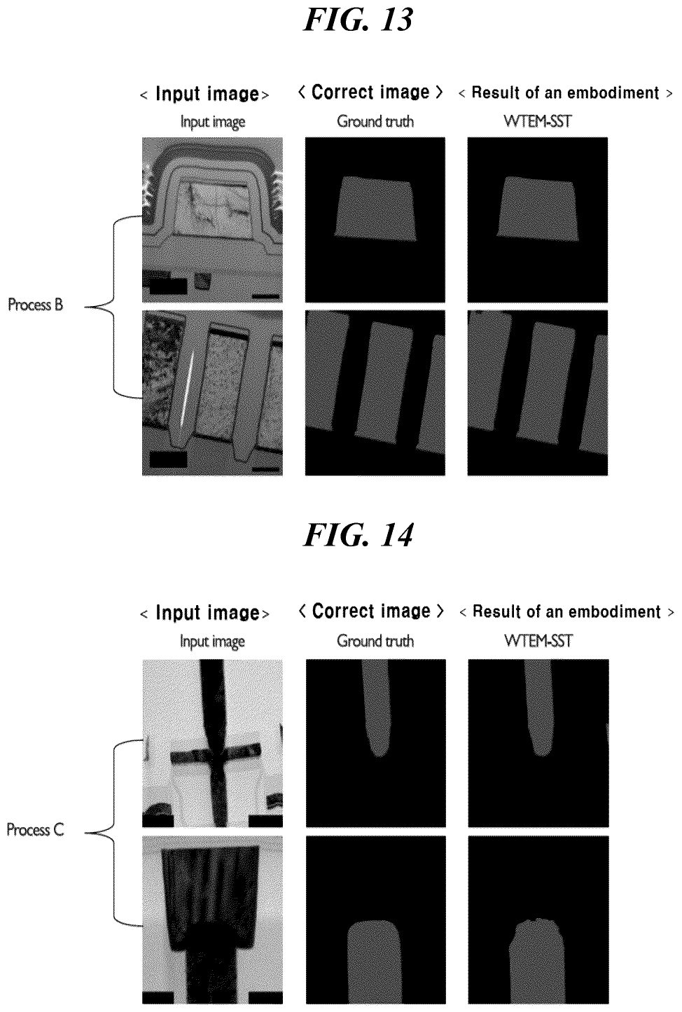

FIG. 11 illustrates an electronic device 100 for augmenting image data for machine learning on electron microscope images, according to one embodiment of the present disclosure.

Referring to FIG. 11, the electronic device 100 may be a computer device. The electronic device 100 may include a processor 110 and a memory 120. The processor 110 may be a processing unit. The processor 110 may include at least one processor. The memory 120 may store one or more instructions. The processor 110 may be configured to, by executing the one or more instructions, perform the following steps: receiving an input image captured by an electron microscope and applying a data augmentation technique to the input image to generate an augmented image dataset. In addition, the processor 110 may be configured to, by executing the one or more instructions, perform one or more of the following steps for generating the augmented image dataset, generating a first transformed image in which an interior region of an object region of interest in the input image is converted to a single color, generating a second transformed image in which a region other than the object region of interest in the input image is converted to a single color, and generating a third transformed image in which pixel positions are changed only within the object region of interest in the input image. The input image may be a TEM image or a SEM image.

According to one embodiment of the present disclosure, the step of generating the first transformed image may include converting the interior region of the object region of interest in the input image to a single color, and/or the step of generating the second transformed image may include converting the region other than the object region of interest in the input image to a single color, wherein the single color may be any one of black, white, and gray.

According to one embodiment of the present disclosure, in the step of generating the first transformed image and/or in the step of generating the second transformed image, the single color may be black.

According to one embodiment of the present disclosure, the step of generating the third transformed image with changed pixel positions only in the interior of the object region of interest in the input image may be performed in a manner that preserves the contour shape of the object region of interest. In addition, this step may be performed so as not to change the size of the object region of interest.

According to one embodiment of the present disclosure, in one or more of the steps of generating the first transformed image, generating the second transformed image, and generating the third transformed image, the processor may be configured to utilize position information of the object region of interest obtained from a correct image or a reference image.

In addition, all of the features and configurations of the embodiments previously described with reference to FIGS. 1 to 3, 7, 8, and 10 may also apply to the electronic device 100 of FIG. 11. In addition, the electronic device 100 may include additional components such as input/output interfaces, input/output devices, network communication interfaces, and the like.

According to another embodiment of the present disclosure, an apparatus including the above-mentioned electronic device 100 may be provided as a device for deriving object regions of interest using machine learning from images captured by an electron microscope. In addition, such an apparatus may be connected to or integrated with an instrumentation device for measuring images related to a semiconductor manufacturing process.

Table 1 below presents the mean intersection over union (MIOU) results when a machine learning model is used to derive object regions of interest from an electron microscope image (e.g., TEM image) using methods from both embodiments and comparative examples. These embodiments and comparative examples are based on the wafer TEM images-specific semantic segmentation and transfer learning (WTEM-SST) framework. The embodiment incorporates the data augmentation technique described in FIG. 10, whereas the comparative example does not utilize the data augmentation technique of the embodiment. The results in Table 1 were obtained from five iterations.

TABLE 1

| | Process A | Process B | Process C | Process D | Process E | Average |
|---|---|---|---|---|---|---|
| Comparative | 97.90 | 96.83 | 94.60 | 99.08 | 89.75 | 95.63 |
| example | (0.82) | (1.88) | (4.99) | (0.49) | (0.96) | (4.04) |
| Embodiment | 98.68 | 98.38 | 98.11 | 99.21 | 89.42 | 96.76 |
| | (0.37) | (0.56) | (0.33) | (0.39) | (0.92) | (3.80) |

Referring to Table 1, the MIOU scores for TEM images across different semiconductor manufacturing processes are shown, along with the average MIOU score. Also, in Table 1, the standard deviation for each case is indicated in parentheses. The results show that the average MIOU score when applying the method according to the embodiment is 96.76%, compared to 95.63% for the comparative example. This increase of approximately 1% or more demonstrates a significant improvement in the accuracy of the machine learning model. In addition, the standard deviation for the embodiment is smaller than that of the comparative example, indicating improved consistency in prediction performance. This suggests that applying the data augmentation technique described in the embodiment leads to higher accuracy and more stable performance of the machine learning model when deriving object regions of interest from TEM images.

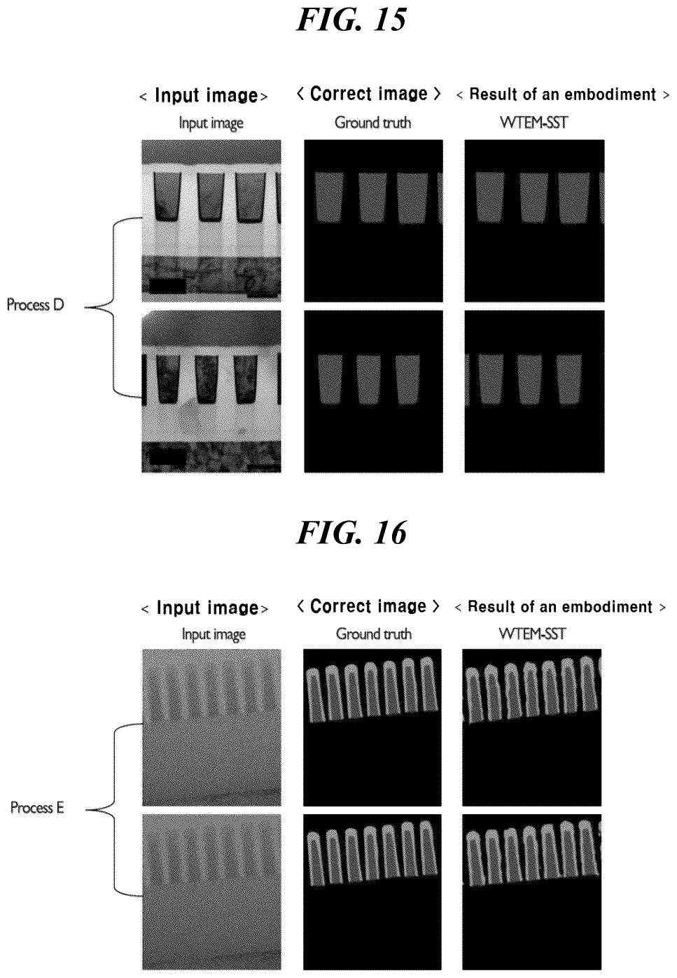

FIGS. 12 through 16 illustrate input images, correct images, and results of a method according to an embodiment, for samples (device part samples) obtained from five different manufacturing processes listed in Table 1. FIG. 12 is for Process A, FIG. 13 is for Process B, FIG. 14 is for Process C, FIG. 15 is for Process D, and FIG. 16 is for Process E.

Referring to FIGS. 12 through 16, the image of the object region of interest (metrology region of interest) obtained using the method according to the embodiment of the present disclosure matches the correct image.

According to the embodiments of the present disclosure described above, a data augmentation method and apparatus suitable for electron microscope images can be implemented to improve the performance of automatic measurement based on machine learning in the manufacturing and development of semiconductor devices. Furthermore, these embodiments enable a data augmentation method and apparatus that allow a machine learning model to clearly recognize the boundary of an object region of interest (metrology region of interest), thereby improving the object recognition performance of the machine learning model.

Additionally, embodiments of the present disclosure provide a method for deriving an object region of interest from an electron microscope image by applying the aforementioned data augmentation method. Likewise, an apparatus for deriving an object region of interest from such images can be implemented using the aforementioned data augmentation apparatus. According to embodiments, by augmenting scarce image information while preserving boundary information in electron microscopy images, these methods and devices enhance image metrology performance based on artificial intelligence models, particularly for electron microscope images such as TEM images and SEM images.

This description discloses preferred embodiments of the present disclosure, and although certain terms are used, they are used in a general sense only to facilitate the description and understanding of the invention and are not intended to limit the scope of the invention. In addition to the embodiments disclosed herein, other modifications based on the technical ideas of the present disclosure will be apparent to those of ordinary skill in the art to which the present invention belongs. One of ordinary skills in the art will recognize that the data augmentation methods and apparatus for machine learning and their utilization in accordance with the embodiments described with reference to FIGS. 1 to 3, 7, 8, and 10 to 16 may be variously substituted, altered, and modified without departing from the technical ideas of the present invention. Accordingly, the scope of the invention is not to be defined by the embodiments described, but rather by the technical ideas recited in the patent claims.

What is claimed is:

1. A computer-implemented method for data augmentation in electron microscope imaging, the method comprising:
receiving, using a processor, an input image captured by an electron microscope;
processing, using a processor, the input image to generate an augmented image dataset, the processing comprising:
generating a first transformed image by converting an interior region of an object region of interest in the input image to a single color;
generating a second transformed image by converting a region other than the object region of interest in the input image to a single color; and
generating a third transformed image by modifying pixel positions exclusively within the interior region of the object region of interest in the input image; and
outputting the augmented image dataset to train a machine learning model.

2. The computer-implemented method of claim 1, wherein, in at least one of generating the first transformed image or generating the second transformed image, the single color is selected from black, white, or gray.

3. The computer-implemented method of claim 2, wherein the single color is black.

4. The computer-implemented method of claim 1, wherein generating the third transformed image is performed not to change a contour shape of the object region of interest.

5. The computer-implemented method of claim 1, wherein generating the third transformed image is performed not to change a size of the object region of interest.

6. The computer-implemented method of claim 1, wherein at least one of generating the first transformed image, generating the second transformed image, or generating the third transformed image includes utilizing positional information of the object region of interest obtained from a correct image or reference image.

7. The computer-implemented method of claim 1, wherein the input image is a transmission electron microscope (TEM) image or a scanning electron microscope (SEM) image.

8. A computer-implemented method of deriving object regions of interest from images captured by an electron microscope, the method comprising:
receiving an augmented image dataset generated using the data augmentation method of claim 1;
training a machine learning model using the augmented image dataset; and
deriving an object region of interest using the trained machine learning model.

9. An electronic device for augmenting image data for machine learning on images captured by an electron microscope, the device comprising:
a processor; and
a memory storing one or more instructions that, when executed by the processor, cause the processor to:
receive an input image captured by the electron microscope; and
generate an augmented image dataset by applying data augmentation techniques to the input image,
wherein generating the augmented image dataset includes performing at least one of:
generating a first transformed image by converting an interior region of an object region of interest in the input image to a single color;
generating a second transformed image by converting a region other than the object region of interest in the input image to a single color; or
generating a third transformed image by modifying pixel positions exclusively within the interior region of the object region of interest in the input image.

10. The device of claim 9, wherein, in at least one of generating the first transformed image or generating the transformed image, the single color is selected from black, white, or gray.

11. The device of claim 10, wherein the single color is black.

12. The device of claim 9, wherein generating the third transformed image is performed not to change a contour shape of the object region of interest.

13. The device of claim 9, wherein generating the third transformed image is performed not to change a size of the object region of interest.

14. The device of claim 9, wherein in at least one of generating the first transformed image, generating the second transformed image, and generating the third transformed image includes utilizing positional information of the object region of interest obtained from a correct image or reference image.

15. The device of claim 9, wherein the input image is a transmission electron microscope (TEM) image or a scanning electron microscope (SEM) image.

16. An electronic device for deriving object regions of interest from images captured by an electron microscope using machine learning, the device comprising:
the electronic device of claim 9.
